(19) United States
(12) Patent Application Publication
(10) Pub. No.: US 2019/0058204 A1
(43) Pub. Date: Feb. 21, 2019

(54) PROTECTIVE INTERLAYER COATING ON GDL AGAINST MEA SHORTING

(71) Applicant: GM GLOBAL TECHNOLOGY OPERATIONS LLC, Detroit, MI (US)

(72) Inventors: YEH-HUNG LAI, PONTIAC, MI (US); ROLAND J. KOESTNER, PONTIAC, MI (US); SRIKANTH ARISETTY, PONTIAC, MI (US); MEHUL M. VORA, PONTIAC, MI (US)

(21) Appl. No.: 15/679,576

(22) Filed: Aug. 17, 2017

(51) Int. Cl. H01M 8/1004; H01M 8/0258

(52) U.S. Cl. CPC H01M 8/1004; H01M 2008/1095; H01M 8/0258

(57) ABSTRACT

A membrane-electrode assembly (MEA) for use in electrical applications, for example in polymer electrolyte fuel cells (PEFCs), includes a protective high-stiffness interlayer coating interposed between a gas diffusion layer and an ion conducting membrane layer, and includes also a catalyst layer. The interlayer mitigates electrical shorting across the ion conducting membrane layer, for example by providing mechanical support against fiber protrusions from the gas diffusion layers into the ion conducting membrane layer or by smoothing the roughness of the gas diffusion layer. The interlayer is typically a mixture of carbon black and one or more ionomers, and its properties are controlled by modulating its thickness, mechanical modulus, ionomer loading, and electrical conductivity.

### TECHNICAL FIELD

In at least one aspect, the present invention relates to a high-stiffness interlayer to be incorporated into membrane-electrode assemblies for the purpose of reducing through-plane electrical shorts from fiber protrusion into electrolyte membranes.

### BACKGROUND

Many approaches to improve the system cost and performance for polymer electrolyte fuel cells (PEFCs) also increase the risk for electrical shorting across the membrane separator layer of the membrane-electrode assembly (MEA). These include thinner membrane layers for lower proton resistance, thinner gas diffusion layers for lower cost, higher cell compression for lower electrical resistance from the flow field plate through the gas diffusion layer and thinner electrode layers for lower Pt loading. An electrical short across the membrane separator induces ohmic heating during operation which can lead to ionomer decomposition if the local temperature reaches 280° C. [1,2]. Sufficient membrane degradation requires a cell replacement in the fuel cell stack.

Two types of membrane shorts have been observed during the fuel cell testing: soft and hard shorts. A soft short is a sub-critical short that results when conductive carbon fibers protrude into the membrane layer. These shorts do not immediately lead to fuel cell failure; however, a significant accumulation can reduce the overall cell resistance and compromise fuel cell durability through cell voltage degradation. Soft shorts are categorized by an electrical resistance through the membrane layer that is below about 140Ω. The protrusion of carbon fiber into the membrane is often caused by a mechanical stress on a loose fiber at the membrane surface or on an oriented fiber emerging from the gas diffusion layer. The stress can force the fiber into the membrane layer during the MEA manufacturing process, fuel cell assembly process, or fuel cell operation.

A hard short is a critical short that causes significant reactant gas crossover of the membrane separator and cell failure. Hard shorts occur suddenly in an operating fuel cell stack when a high shorting current passes through an existing membrane soft short with sufficiently low electrical resistance that causes excessive ohmic heating and high local temperature. When the temperature of membrane surrounding the soft short reaches its decomposition temperature, the membrane loses its mechanical integrity and thereby allows direct contact of the conductive catalyst layers and gas diffusion layers from both sides of the membrane that gives a large shorting current and significant heat generation. The hard short typically originates from a soft short of less than 140 Ω when the cell potential exceeds than 2 V.

Accordingly, there is a need for membrane-electrode assemblies with reduced propensities for through-plane electrical shorts.

### SUMMARY

The present invention is directed to solving one or more problems of the prior art by providing, in at least one embodiment, a membrane-electrode assembly (MEA), for fuel cell applications, having a high-stiffness interlayer interposed between a gas diffusion layer and a conducting membrane layer to mitigate electrical shorting across the conducting membrane layer. The membrane-electrode assembly additionally includes a catalyst layer interposed between the gas diffusion layer and the conducting membrane layer. The stiffness of the interlayer may be controlled by varying, for example, ionomer content and thickness with minimal loss in gas or proton transport to the active catalyst site in the electrode layers.

In one embodiment, a membrane-electrode assembly with a high-stiffness interlayer interposed between the gas diffusion and electrode layers is incorporated within a polymer electrolyte fuel cell (PEFC), wherein the MEA is interposed between two electrically conductive flow field plates further comprising channels for reactive gases.

In another embodiment, a high-stiffness interlayer is interposed between the electrode and membrane layers within a PEFC cell. A method for fabricating the high-stiffness interlayer set forth is provided which includes steps for making a dispersion, for example of a carbon black and one or more ionomers, milling the dispersion, and applying the dispersion to a substrate layer of an MEA.

### BRIEF DESCRIPTION OF THE DRAWINGS

FIG. 1A provides a schematic illustration of a typical polymer electrolyte fuel cell (PEFC) containing a high-stiffness interlayer as configured in a first variation of one embodiment;

FIG. 1B provides a schematic illustration of a typical polymer electrolyte fuel cell (PEFC) containing a high-stiffness interlayer as configured in a second variation of one embodiment;

FIG. 2 provides an optical cross-section showing the presence of a carbon fiber within a 20 μm unreinforced membrane layer after laminating between gas diffusion layer (GDL) sheets;

FIG. 3 provides an optical cross-section showing thinning of a 20 μm reinforced membrane layer after laminating between gas diffusion layer (GDL) sheets;

FIG. 4A provides a plot of indentation modulus versus ionomer/carbon ratio for a 12 μm interlayer;

FIG. 4B provides a plot of indentation modulus versus percent ionomer saturation for a 12 μm interlayer;

FIG. 5A provides a depiction of the measurement of a soft short at 0.6 V across a GDL-membrane-GDL sample from a 0.50 cm² element array at 3.0 MPa compression;

FIG. 5B provides a depiction of the measurement of a hard short at 3.0 V across the same GDL-membrane-GDL sample from a 0.50 cm² element array at 3.0 MPa compression;

FIG. 6 provides a depiction of the detection of a hard short after incrementing the compression on a GDL-membrane-GDL laminate at an applied 3.0 V potential;

FIG. 7 shows an optical top-down view for a cathode-side through-layer hole in the membrane layer with a 500 μm diameter for a PEFC due to ionomer decomposition from a hard electrical short;

FIG. 8 provides an interlayer comparison of soft short density for 0.50 cm² area elements across a symmetric GDL-membrane-GDL laminate at 0.6 V and 3.0 MPa;

FIG. 9 provides a plot of shorting density vs MPL-interlayer stiffness indicating that soft short density is reduced for a symmetric GDL-membrane-GDL laminate with 9 and 16 μm thick interlayer coatings on the commercial MPL; and

FIG. 10 provides a plot of voltage vs current density indicating that the insertion of a 9 μm thick interlayer at I/C=0.8 does not significantly impact cell performance under wet conditions at 1.5 A/cm² or lower current density.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

### Abbreviations

“BET” means surface area as determined using the Brunauer, Emmett, and Teller equation.

“DMA” means dynamic mechanical analysis.

“ePTFE” means expanded polytetrafluoroethylene.

“ETFE” means ethylene-tetrafluoroethylene co-polymer.

“GDL” means gas diffusion layer.

“I/C” means ionomer:carbon weight/weight ratio.

“MEA” means membrane-electrode assembly.

“MPL” means microporous layer.

“PEFC” means polymer electrolyte fuel cell.

“RH” means relative humidity.

“SEM” means scanning electron microscopy.

The following examples illustrate various embodiments of the present invention. Those skilled in the art will recognize many variations that are within the spirit of the present invention and scope of the claims.

Embodiments of the present invention provide a membrane-electrode assembly (MEA), for fuel cell applications, having a high-stiffness interlayer interposed between a gas diffusion layer and a conducting membrane layer to mitigate electrical shorting across the conducting membrane layer. The membrane-electrode assembly additionally includes a catalyst layer interposed between the gas diffusion layer and the conducting membrane layer. The catalyst may be, for example, platinum-, ruthenium-, platinum ruthenium-, palladium-, iridium-, silver-, gold-, cobalt-, copper-, iron-, nickel-, rhodium-, tin-, or carbon-based, or a combination thereof, among others. The stiffness of the interlayer may be controlled by varying, for example, ionomer content and thickness with minimal loss in gas or proton transport to the active catalyst site in the electrode layers.

In one embodiment, a membrane-electrode assembly with a high-stiffness interlayer interposed between the gas diffusion and electrode layers is incorporated within a polymer electrolyte fuel cell (PEFC), wherein the MEA is interposed between two electrically conductive flow field plates further comprising channels for reactive gases.

In another embodiment, a high-stiffness interlayer is interposed between the electrode and membrane layers within a PEFC cell. A method for fabricating the high-stiffness interlayer set forth is provided which includes steps for making a dispersion, for example of a carbon black and one or more ionomers, milling the dispersion, and applying the dispersion to a substrate layer of an MEA.

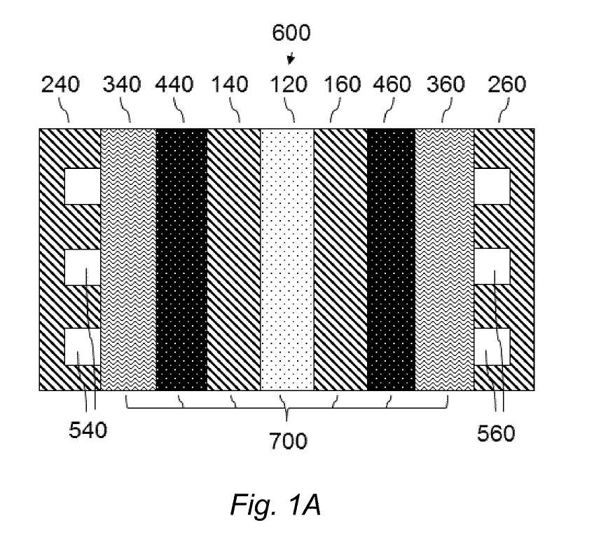

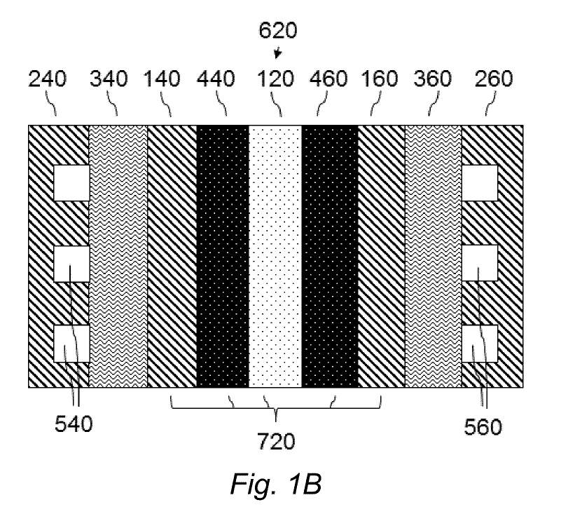

With reference to FIG. 1a, a schematic cross section of a polymer electrolyte fuel cell that incorporates a first variation of an embodiment of a membrane-electrode assembly containing a high-stiffness interlayer is provided. Polymer electrolyte fuel cell 600 includes a polymeric ion conducting membrane 120 disposed between an anode catalyst layer 140 and a cathode catalyst layer 160. Disposed over the anode catalyst layer 140 is a first high-stiffness interlayer 440, and disposed over the cathode catalyst layer 160 is a second high-stiffness interlayer 460. Disposed over the first high-stiffness interlayer 440 is a first gas diffusion layer 340, and disposed over the second high-stiffness interlayer 460 is a second gas diffusion layer 360. Disposed over the first gas diffusion layer 340 is a first electrically conductive flow field plate 240, and disposed over the second gas diffusion layer 360 is a second electrically conductive flow field plate 260.

The first and second electrically conductive flow field plates 240 and 260 further comprise gas channels 540 and 560. Within the polymer electrolyte fuel cell 600, the membrane-electrode assembly portion 700 comprises the polymeric ion conducting membrane 120, the anode catalyst layer 140, the cathode catalyst layer 160, the first gas diffusion layer 340, the second gas diffusion layer 360, the first high-stiffness interlayer 440, and the second high-stiffness interlayer 460. During operation of the fuel cell 600, a fuel such as hydrogen is fed to the flow field plate 240 on the anode side, and an oxidant such as oxygen is fed to the flow field plate 260 on the cathode side. The hydrogen gas passes through the first gas diffusion layer 340 and the first high-stiffness interlayer 440. The oxygen gas passes through the second gas diffusion layers 360 and the second high-stiffness interlayer 460. Hydrogen ions are generated by anode catalyst layer 140 and migrate through polymeric ion conducting membrane 120 where they react at cathode catalyst layer 160 with the oxygen to form water. This electrochemical process generates an electric current through the motion of electrons from the anode catalyst layer 140 to the cathode catalyst layer 160 through an external circuit. Preferably, the interlayer stiffness is typically from about 5 to about 19 N/mm, and the soft short density in a fuel cell incorporating the interlayer is at least about 2-fold lower than for an otherwise identical fuel cell operating under comparable conditions. The interlayer porosity may generally be from about 0% to about 80% v/v.

With reference to FIG. 1b, a schematic cross section of a fuel cell that incorporates a second variation of an embodiment of a membrane-electrode assembly containing a high-stiffness interlayer is provided. Polymer electrolyte fuel cell 620 includes a polymeric ion conducting membrane 120 disposed between a first high-stiffness interlayer 440 and a second high-stiffness interlayer 460. Disposed over the first high-stiffness interlayer 440 is an anode catalyst layer 140, and disposed over the second high-stiffness interlayer 460 is a cathode catalyst layer 160. Disposed over the anode catalyst layer 140 is a first electrically conductive flow field plate 240, and disposed over the cathode catalyst layer 160 is a second electrically conductive flow field plate 260. Disposed over the first electrically conductive flow field plate 240 is a first gas diffusion layer 340, and disposed over the second electrically conductive flow field plate 260 is a second gas diffusion layer 360.

The first and second electrically conductive flow field plates 240 and 260 further comprise gas channels 540 and 560. Within the polymer electrolyte fuel cell 620, the membrane-electrode assembly portion 720 comprises the polymeric ion conducting membrane 120, the anode catalyst layer 140, the cathode catalyst layer 160, the first gas diffusion layer 340, the second gas diffusion layer 360, the first high-stiffness interlayer 440, and the second high-stiffness interlayer 460. During operation of the fuel cell 620, a fuel such as hydrogen is fed to the flow field plate 240 on the anode side, and an oxidant such as oxygen is fed to the flow field plate 260 on the cathode side. The hydrogen and oxygen gas pass through the first and second gas diffusion layers 340 and 360, respectively. Hydrogen ions are generated by anode catalyst layer 140 and migrate through polymeric ion conducting membrane 120 where they react at cathode catalyst layer 160 with the oxygen to form water. This electrochemical process generates an electric current through the motion of electrons from the anode catalyst layer 140 to the cathode catalyst layer 160 through an external circuit. In a refinement, the first high-stiffness interlayer and the second high-stiffness interlayer each independently has a stiffness from about 5 N/mm to about 30 N/mm. In another refinement, the first high-stiffness interlayer and the second high-stiffness interlayer each independently have a stiffness from about 10 to about 30 N/mm, and the soft short density in a fuel cell incorporating the interlayer is at least about 2-fold lower than for an otherwise identical fuel cell operating under comparable conditions. In some variations, the first high-stiffness interlayer and the second high-stiffness interlayer each independently has a porosity from about 0% to about 80% v/v. In general, the first high-stiffness interlayer and the second high-stiffness interlayer have a porosity from about 0% to about 20% v/v.

In a refinement of both variations of the embodiment membrane-electrode assembly 700 or 720 described above and depicted in FIG. 1a or FIG. 1b, the high-stiffness interlayers 440 or 460 further comprise a mixture of carbon black and one or more ionomers, wherein the stiffness of each of the interlayers are controlled by varying ionomer loading and thickness. Advantageously, the interlayer indentation modulus increases with ionomer loading. The one or more ionomer may be, for example, polystyrene sulfonate, poly(ethylene-co-methacrylic acid) (e.g., Surlyn), sulfonated tetrafluoroethylene based fluoropolymer copolymer (e.g, Nafion, Flemion, Aciplex, Fumion F), neutral organic-base copolymers, neutral organic-acid copolymers, nonionic-ionic copolymers, or combinations thereof, among others. In a further refinement, the one or more ionomers comprise a mixture of equivalent weight 700 (EW700) and equivalent weight 900 (EW900).

In a refinement of both variations of the embodiment membrane-electrode assembly 700 or 720 described above and depicted in FIG. 1a or FIG. 1b, the high-stiffness interlayers 440 and/or 460 each independently has a thickness from about 5 μm to about 25 μm. In a refinement, the high-stiffness interlayers 440 or 460 each independently has a thickness from about 9 μm to about 16 μm. In a refinement, the high-stiffness interlayers 440 and/or 460 each independently has a thickness from about 2 μm to about 20 μm.

In a refinement of both variations of the embodiment membrane-electrode assembly 700 or 720 described above and depicted in FIG. 1a or FIG. 1b, the high-stiffness interlayers 440 or 460 each independently has an indentation modulus from about 0.4 to about 2.3.

In a refinement of both variations of the embodiment membrane-electrode assembly 700 or 720 described above and depicted in FIG. 1a or FIG. 1b, the high-stiffness interlayers 440 or 460 each independently has an ionomer/carbon (I/C) weight/weight ratio from about 0.5 to about 3.2.

In a refinement, the first or second high-stiffness interlayer has a sufficiently low ionomer loading such that an optimal balance between electrical shorting and reactant gas transport resistance to the electrode catalyst is achieved.

In another refinement, wherein the first or second high-stiffness interlayer has a sufficiently high ionomer loading such that an optimal balance between electrical shorting in the membrane separator and proton transport resistance to the electrode catalyst is achieved.

In a refinement of the variations 600 and 620 described above and depicted in FIG. 1a or FIG. 1b, flow field plates 240 and 260 are either bipolar plates (illustrated) or unipolar plates (i.e., end plates). The gas diffusion layers 340 and 360 are typically constructed from a carbon fiber with 7 or 10 μm diameter, a carbon-based resin for cohesion, and a fluoropolymer for wet-proofing. The carbon fiber layer provides effective gas and electrical transport in both in-plane and through-plane directions for the land-channel geometry of the flow field plate. However, these carbon fibers if properly oriented can easily penetrate the membrane separator under cell compression due to the relatively low mechanical modulus of the ionomer film (which is typically 200-400 MPa for commercially available membrane as measured by dynamic mechanical analysis, DMA).

In another embodiment, a method for applying the high-stiffness interlayer set forth above to the membrane-electrode assembly is provided. A method for fabricating the high-stiffness interlayer set forth is provided which includes steps for making a dispersion, for example of a carbon black and one or more ionomers, milling the dispersion, and applying the dispersion to a substrate layer of an MEA.

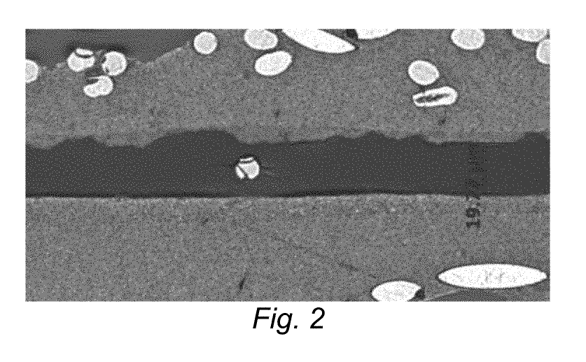

With reference to FIG. 2, an optical cross-section of a 20 μm unreinforced membrane layer laminated between two gas diffusion layers (GDLs) with a soft short is provided. The carbon fiber has a circular diameter near 7 μm; in this case, one fiber has penetrated to the center of the 20 μm thick membrane which lowers the electrical resistance of the insulating layer.

The GDL, which includes both the carbon fiber substrate and a microporous layer (MPL), has an approximate 100 to 300 μm thickness at 0.03 MPa compression. The MPL layer itself has an approximate 40 μm thickness and comprises a carbon black with a 50-200 nm pore diameter and a fluoropolymer for wetproofing. The fluoropolymer is added as a fine 200 nm diameter particle which flows above its melting temperature (270-330° C.) during a sintering step (340-400° C.) to remove hydrocarbon-based coating additives, but does not provide a sufficient mechanical modulus to resist fiber protrusion.

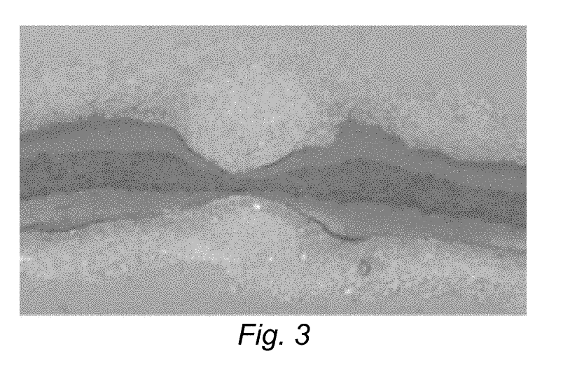

With reference to FIG. 3, another optical cross-section of a 20 μm reinforced membrane layer laminated between two GDL sheets with another soft short is provided. In this case, the surface roughness of the two opposing gas diffusion layers is aligned to thin the membrane layer to the center ePTFE (expanded polytetrafluoroethylene) reinforcement mesh.

### Interlayer Fabrication

In a variation, graphitized Vulcan® carbon black (33 nm solid carbon particle diameter, 90 m²/g BET) is dispersed in n-propanol-water solvent (nPrOH:H₂O::3:1 w/w) with a blend of two ionomer equivalent weights (EW900:EW700::3:1 w/w). The carbon loading is formulated at 5.0% w/w ink, while the ionomer loading is stepped in separate inks from 0.80 to 1.20 to 1.60 w/w carbon. The carbon black dispersion is milled with ZrO₂ beads and coated directly onto the GDL substrate with a set of Mayer rods with a normalized thickness of 21.0±0.5 μm/(mg C/cm²), which corresponds to a carbon porosity at 76.0% v/v. Table 1 lists the actual coated thickness measured by SEM cross-section for each interlayer ink at two laydowns.

TABLE 1
Actual coated thickness measured by SEM cross-section
for each interlayer ink at two laydowns.

| Ink I/C | Mayer | Carbon | Ionomer | Thickness |
|---|---|---|---|---|
| (w/w) | Rod (#) | (mg/cm2) | (mg/cm2) | (μm) |
| 0.80 | 50 | 0.433 | 0.346 | 9.1 |
| 0.80 | 100 | 0.778 | 0.622 | 16.3 |
| 1.20 | 50 | 0.445 | 0.534 | 9.3 |
| 1.20 | 100 | 0.759 | 0.911 | 15.9 |
| 1.60 | 50 | 0.425 | 0.679 | 8.9 |
| 1.60 | 100 | 0.767 | 1.227 | 16.1 |

Advantageously, the interlayer indentation modulus increases with ionomer loading. Table 2 lists the indentation modulus for reference interlayer coatings at 12 μm thickness on a solid ETFE (ethylene-tetrafluoroethylene co-polymer) substrate. The mechanical modulus (E′, GPa) is measured at five ionomer loadings with a Micromechanical Laboratory's MTS Nanoindenter XP device at 0.5 mN load equipped with a 5 μm radius 60° conical diamond tip stylus. Each coating is first conditioned at least 24 hours at 70 F/50% RH, and five replicate measurements are averaged. The modulus is extracted using Testworks software following the Oliver and Pharr method [3]. In a direct comparison, the nanoindentation and DMA methods do show good agreement in the measured modulus at room temperature for commercially available membrane films.

TABLE 2
Interlayer indentation modulus for reference interlayer
coatings at 12 μm thickness on a solid ETFE (ethylene-
tetrafluoroethylene co-polymer) substrate

Modulus (E′, GPa)

| I/C (w/w) | Saturation (v/v) | Measure | Fit |
|---|---|---|---|
| 0.00 | 0.0% | 0.00 | 0.00 |
| 0.50 | 15.8% | 0.39 | 0.36 |
| 0.70 | 22.1% | 0.46 | 0.50 |
| 0.95 | 30.0% | 0.64 | 0.69 |
| 1.20 | 37.9% | 0.81 | 0.87 |
| 1.40 | 44.2% | 1.10 | 1.01 |
| 1.58 | 50.0% | — | 1.14 |
| 2.38 | 75.0% | — | 1.71 |
| 3.17 | 100.0% | — | 2.28 |

The mechanical modulus increases with ionomer fill volume of the available interlayer carbon porosity. Since the carbon and ionomer have nominally the same material density (2.00 g/cc), the carbon porosity is expected to saturate with ionomer at I/C (w/w)=3.17 as shown in Table 2.

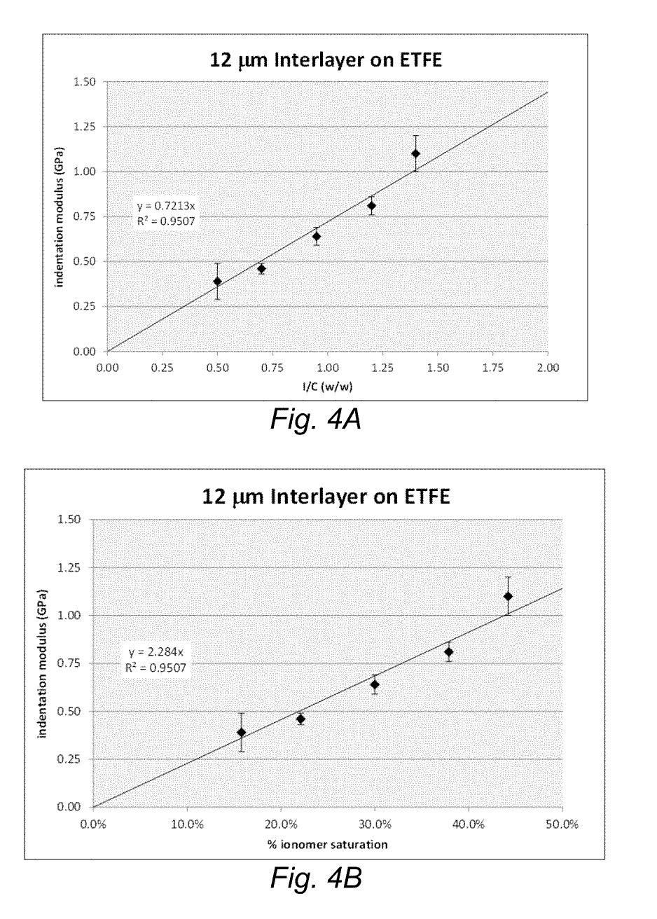

With reference to FIGS. 4a and 4b, plots of the measured nanoindentation modulus for the five reference interlayer coatings on ETFE against ionomer carbon loading (FIG. 4a) or equivalently, ionomer saturation (FIG. 4b) are provided. A linear regression with a fixed intercept at the origin leads to the following equation:

E′(GPa)=0.721*I/C(w/w)

This indicates that the interlayer modulus is proportional to the ionomer loading and ranges from 0-2.3 GPa for 0-3.2 I/C (w/w) or, equivalently, 0-100% ionomer saturation. Above 100% saturation, the carbon network is no longer tightly packed so the mechanical modulus drops significantly.

### Electrical Shorting Measurement

Electrical shorting density can be measured as follows, in characterizing MEAs containing high-stiffness interlayers.

A current distribution circuit board induces uniform compression over a 32 cm² area of a sample that consists of a piece of proton exchange membrane or a membrane electrode assembly sandwiched between two opposing gas diffusion layers [4,5]. The shorting current distribution is measured in 0.5 cm² individual elements by incrementing the compressive pressure a constant applied voltage of 0.6 V. The method determines the density of soft shorts (in shorting counts per unit area) and their ohmic resistance in 64 elements across a 32 cm² sample area that may lead to hard shorts when an adverse fuel cell operating condition is met.

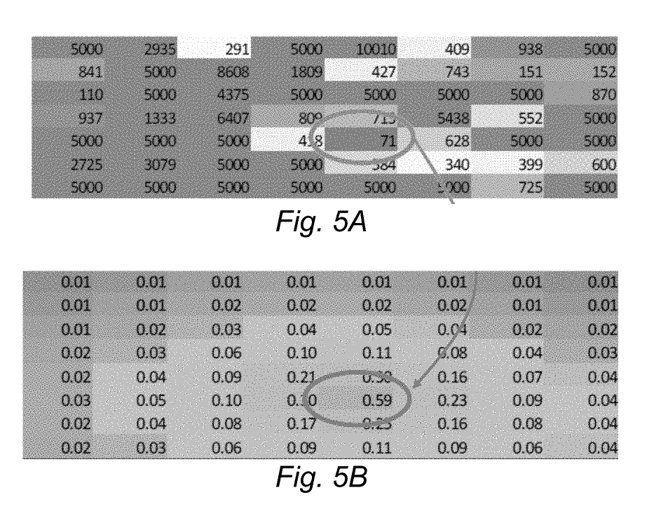

With respect to FIG. 5, an illustration of the deconvolution of a shorting current across adjacent elements on the current density distribution board is provided. The number and severity of each soft short is identified at 3.0 MPa compression in FIG. 5a at 0.6 V where one soft short element at 71Ω leads to a hard shorts at 0.59 A at 3.0 V in FIG. 5b.

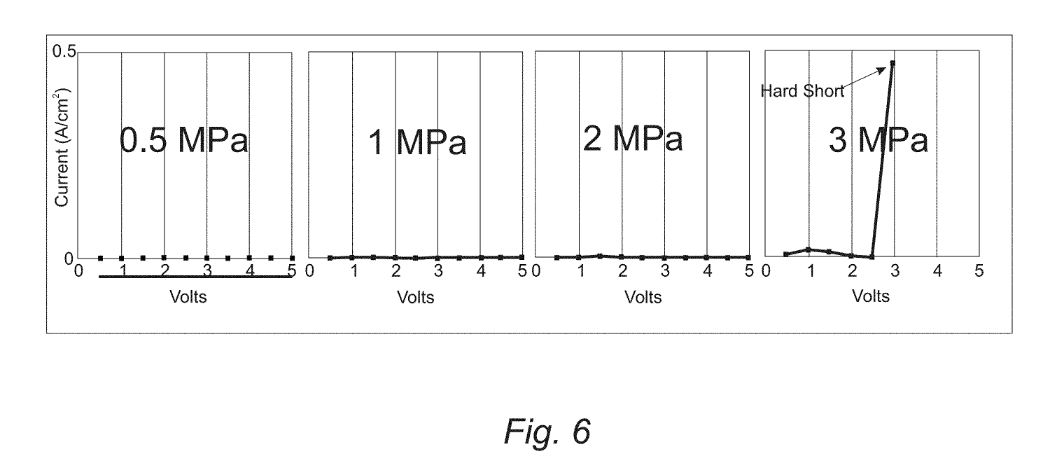

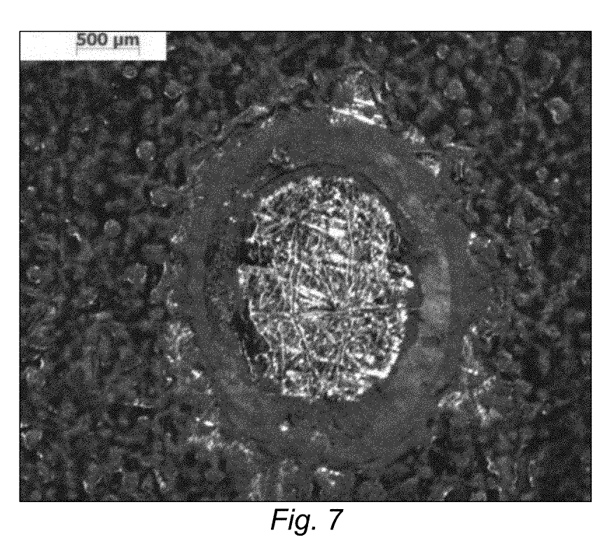

With respect to FIG. 6, a plot of the appearance of a hard short in another GDL-membrane-GDL element as the applied voltage sweeps to 5.0 V for each cell compression step at 0.5 vs 1.0 vs 2.0 vs 3.0 MPa is provided. A hard short only appears after the cell compression step at 3.0 MPa is reached. The hard short probability increases with higher cell compression, higher soft short density, and lower soft short element resistance.

With respect to FIG. 7, a top-down optical image of membrane damage, namely a 500 μm diameter hole that formed after a hard short occurs for a GDL-membrane-GDL laminate is provided. Due to the local ohmic heating, the ionomer membrane was removed, exposing the underlying cathode-side GDL.

Soft Short Mitigation with Interlayer

Advantageously, symmetrical insertion of a high-stiffness interlayer between the gas diffusion layers and a membrane layer improves soft short density in a symmetrical gas diffusion layer/membrane laminate.

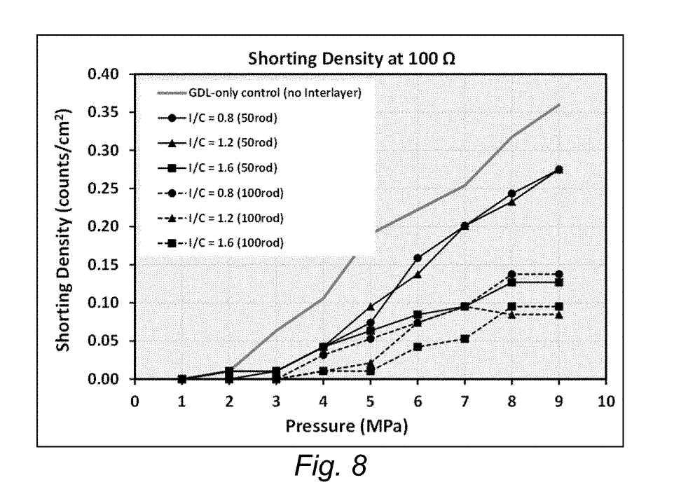

With respect to FIG. 8, a characterization of the improvement in soft short density for a GDL—membrane—GDL laminate with symmetric insertion of a stiff interlayer between the GDL and membrane layers is provided. The soft short density decreases significantly with interlayer thickness and ionomer loading for the interlayer coatings in Table 1. The same commercial 125 μm GDL (with MPL layer) and 20 μm ionomer membrane are used throughout an applied voltage at 0.6 V and cell compression sweep from 1.0-9.0 MPa in 1.0 MPa steps.

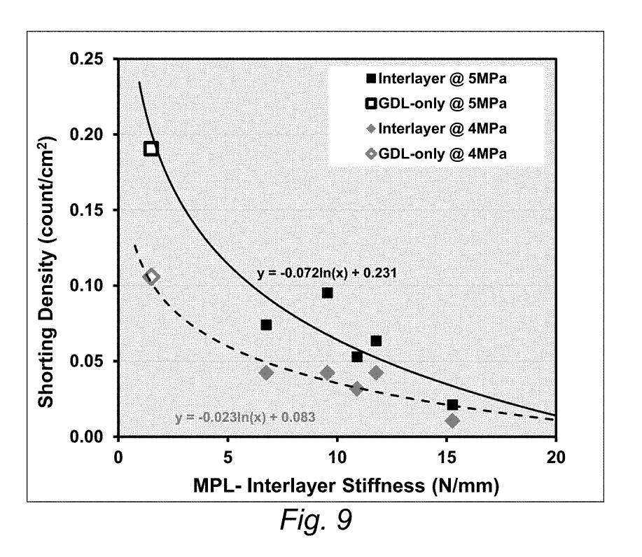

With respect to FIG. 9, a comparison of the shorting density (at 4 and 5 MPa) versus MPL—interlayer stiffness is provided. The shorting density is determined by counting the shorts with a resistance less than 100Ω. The interlayer stiffness is calculated as the product of layer thickness and mechanical modulus, while the MPL layer stiffness is fitted [6, 7]. In an embodiment, preferably, the interlayer stiffness is typically from about 5 to about 19 N/mm, and the soft short density in a membrane electrode assembly incorporating the interlayer is at least about 2-fold lower than for an otherwise identical membrane electrode assembly operating under comparable conditions.

The low mechanical modulus of the commercial MPL layer is implied by its low stiffness even though the layer (40 μm) is substantially thicker than the interlayer samples (9-16 μm). The commercial MPL in FIGS. 8 and 9 does not itself provide sufficient resistance to carbon fiber protrusion, demonstrating the advantage for insertion of a hard interlayer.

### Interlayer Gas Transport Resistance

A variation of an embodiment, for example provided in FIG. 1a, places the interlayer 440 or 460 between gas diffusion layers 340 or 360 and catalyst layers 140 or 160 when a balance between soft short density and gas transport resistance is required.

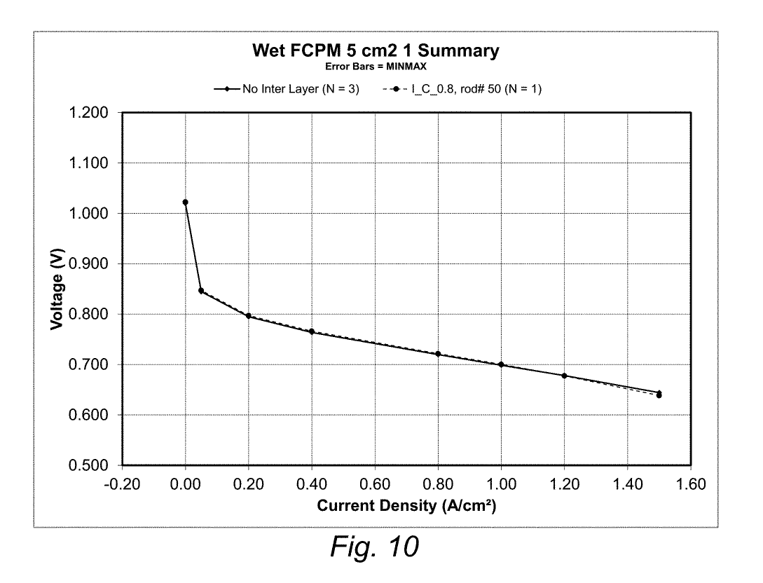

The impact of this resistance is quantified by cell voltage performance in FIG. 10 for two common cell performance protocols. The inlet gases in the wet protocol are supplied at 100% RH and for the dry protocol at 65% RH, while the remaining operating conditions for back pressure and temperature are kept at 270 kPa and 80° C., respectively, for both protocols. The initial measurements show that the interlayer did not cause any penalty in the cell voltage performance at current densities less than 1.5 A/cm².

### Interlayer Proton Transport Resistance

An alternative variation of an embodiment, for example provided in FIG. 1b, places the interlayer 440 or 460 between the catalyst layer 140 or 160 and the membrane layer 120 when a balance between soft short density and proton transport resistance is required. In this case, the interlayer carbon porosity is saturated with ionomer to increase both mechanical stiffness and proton transport to the electrode catalyst layer. As an example, the calculated voltage performance penalty for an ionomer-saturated interlayer at 4 μm thickness is under 10 mV at 1.5 A/cm² at a wet condition of 80° C. and 100% RH.

In this case, with respect to FIG. 10, the mechanical model predicts a MPL-interlayer stiffness above 10 N/mm for a 4 μm thick interlayer with porosity at 0-20% v/v.

While exemplary embodiments and variations are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCES

1) C. S. Gittleman, F. D. Coms, and Y. H. Lai“Chapter, 2: Membrane Durability: Physical and Chemical Degradation”, Polymer Electrolyte Fuel Cell Degradation, Editors: M. M. Mench, E. C. Kumbur and T. N. Veziroglu, Elsevier (2012).
2) A. B. LaConti, M. Hamdan, R. C. McDonald, “Mechanism of Membrane Degradation for PEMFCs”, Handbook of Fuel Cells: Fundamentals, Technology and Applications, W. Vielstich, A. Lamn, H. A. Gasteiger (Eds), Vol. 3, John Wiley & Sons, New York, 2003, pp. 647-662.
3) G. M. Pharr, W. C. Oliver, and F. R. Brotzen, J. Materials Research, Vol. 7, No. 3, 1992.
4) Y. H. Lai, 2016 ECS Abstract. “Shorting in Polymer Electrolyte Fuel Cells: Aspects of Material Testing and Operating Conditions”, October 2016, Honolulu Hi.
5) J. J. Gagliardo, J. P. Owejan, T. A. Trabold, and T. W. Tighe, Nucl. Instrum. Meth. A, 605 (2009) 115-118.
6) Sen et al. “A finite-element analysis of the indentation of an elastic-work hardening layered half-space by an elastic sphere”, International Journal of Mechanical Sciences, Volume 40, Issue 12, 1 Dec. 1998, Pages 1281-1293.
7) van der Zwaagab et al., “The effect of thin hard coatings on the Hertzian stress field”, Philosophical Magazine A, Volume 46, Issue 1, 1982, pages 133-150.

What is claimed is:

1. A membrane-electrode assembly comprising:
a polymeric ion conducting membrane layer having a cathode side and an anode side;
a cathode catalyst layer disposed over the cathode side;
an anode catalyst layer disposed over the anode side;
a first gas diffusion layer disposed over the cathode catalyst layer;
a second gas diffusion layer disposed over the anode catalyst layer;
a first high-stiffness interlayer interposed between the cathode catalyst layer and either the first gas diffusion layer or the polymeric ion conducting membrane layer; and
a second high-stiffness interlayer interposed between the anode catalyst layer and either the second gas diffusion layer or the polymeric ion conducting membrane layer;
wherein the first high-stiffness interlayer and the second high-stiffness interlayer each independently has a stiffness from about 5 N/mm to about 30 N/mm;
wherein the first high-stiffness interlayer and the second high-stiffness interlayer each independently has a porosity from about 0% to about 80% v/v; and
wherein the first and second high-stiffness interlayer reduce the soft short density of the membrane-electrode assembly by about at least a factor of 2 relative to an otherwise identical assembly having no high-stiffness interlayer by providing mechanical support against fiber protrusions from the first and second gas diffusion layers into the polymeric ion conducting membrane layer or by smoothing the roughness of the first and second gas diffusion layers.

2. The membrane-electrode assembly of claim 1, wherein the first high-stiffness interlayer is interposed between the first gas diffusion layer and the cathode catalyst layer and the second high-stiffness interlayer is interposed between the second gas diffusion layer and the anode catalyst layer.

3. The membrane-electrode assembly of claim 1, wherein the first high-stiffness interlayer is interposed between the polymeric ion conducting membrane layer and the cathode catalyst layer and the second high-stiffness interlayer is interposed between the polymeric ion conducting membrane layer and the anode catalyst layer.

4. The membrane-electrode assembly of claim 1, wherein the first or second high-stiffness interlayers further comprises a mixture of carbon black and one or more ionomers and the stiffness of each of the first and second high-stiffness interlayers are controlled by varying ionomer loading and thickness.

5. The membrane-electrode assembly of claim 2, wherein the one or more ionomers further comprises a mixture of equivalent weight 700 (EW700) and equivalent weight 900 (EW900).

6. The membrane-electrode assembly of claim 2, wherein the first or second high-stiffness interlayer has a thickness from about 5 to 25 μm.

7. The membrane-electrode assembly of claim 2, wherein the first or second high-stiffness interlayer has an indentation modulus from about 0.4 to about 2.3.

8. The membrane-electrode assembly of claim 2, wherein the first or second high-stiffness interlayer has an ionomer/carbon (I/C) weight/weight ratio from about 0.5 to about 3.2.

9. A polymer electrolyte fuel cell comprising:
a first electrically conductive flow field plate, further comprising a first gas channel;
a second electrically conductive flow field plate, further comprising a second gas channel; and
a membrane-electrode assembly comprising:
a polymeric ion conducting membrane layer having a cathode side and an anode side;
a cathode catalyst layer disposed over the cathode side;
an anode catalyst layer disposed over the anode side;
a first gas diffusion layer disposed over the cathode catalyst layer;
a second gas diffusion layer disposed over the anode catalyst layer;
a first high-stiffness interlayer interposed between the cathode catalyst layer and either the first gas diffusion layer or the polymeric ion conducting membrane layer; and
a second high-stiffness interlayer interposed between the anode catalyst layer and either the second gas diffusion layer or the polymeric ion conducting membrane layer;
wherein the first high-stiffness interlayer and the second high-stiffness interlayer each independently has a stiffness of at least about 5 N/mm; and
wherein the first and second high-stiffness interlayer reduce the soft short density of the membrane-electrode assembly by about at least a factor of 2 relative to an otherwise identical assembly having no high-stiffness interlayer by providing mechanical support against fiber protrusions from the first and second gas diffusion layers into the polymeric ion conducting membrane layer or by smoothing the roughness of the first and second gas diffusion layers and the membrane-electrode assembly is interposed between the first and second electrically conductive flow field plates;

10. The polymer electrolyte fuel cell of claim 9, wherein the first or second electrically conductive flow field plate is each independently a bipolar plate or a unipolar plate.

11. The polymer electrolyte fuel cell of claim 9, wherein the first gas channel or second gas channel is independently a plurality of gas channels.

12. The polymer electrolyte fuel cell of claim 9, wherein the first high-stiffness interlayer is interposed between the first gas diffusion layer and the cathode catalyst layer; and the second high-stiffness interlayer is interposed between the second gas diffusion layer and the anode catalyst layer.

13. The polymer electrolyte fuel cell of claim 9, wherein the first high-stiffness interlayer is interposed between the polymeric ion conducting membrane layer and the cathode catalyst layer; and
wherein, the second high-stiffness interlayer is interposed between the polymeric ion conducting membrane layer and the anode catalyst layer.

14. The polymer electrolyte fuel cell of claim 9, wherein the first or second high-stiffness interlayers further comprise a mixture of carbon black and one or more ionomers and the stiffness of each of the first and second high-stiffness interlayers are controlled by varying ionomer loading and thickness.

15. The polymer electrolyte fuel cell of claim 14, wherein the one or more ionomers further comprises a mixture of equivalent weight 700 (EW700) and equivalent weight 900 (EW900) monomers.

16. The polymer electrolyte fuel cell of claim 14, wherein the first or second high-stiffness interlayer has a thickness from about 2 to 20 μm.

17. The polymer electrolyte fuel cell of claim 14, wherein the first or second high-stiffness interlayer has an indentation modulus from about 0.4 to about 2.3.

18. The polymer electrolyte fuel cell of claim 14, wherein the first or second high-stiffness interlayer has an ionomer/carbon (I/C) weight/weight ratio from about 0.5 to about 3.2.

19. A method for applying a high-stiffness interlayer to a substrate layer of a membrane-electrode assembly comprising the steps of:
a) making a carbon black dispersion by dispersing a portion of carbon black in a solvent with a portion of ionomer;
b) milling the carbon black dispersion with beads; and
c) coating the milled carbon black dispersion directly onto a substrate layer.
